(19) United States
(12) Patent Application Publication
(10) Pub. No.: US 2004/0046397 A1
(43) Pub. Date: Mar. 11, 2004

(54) Fastening system for closing an opening

(76) Inventor: Manfred Klein, Kaufering (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/654,680

(22) Filed: Sep. 4, 2003

(30) Foreign Application Priority Data
Sep. 5, 2002 (DE) 102 40 995.1

(51) Int. Cl. E05B 65/10

(52) U.S. Cl. 292/93

(57) ABSTRACT

A fastening system (11) for closing an opening in a structural part with a plate-type material including a base element (12) and supporting elements. The base element (12) includes a fastening section (15) and an angular section (16). A plurality of receiving means (17.1 to 17.8 and 18.1, 18.2) are provided in a predefined spacing (A) for connecting a plurality of supporting elements (13.1 to 13.6; 14). At least one opening for fastening the base element (12) to an intrados of the opening is associated with each receiving means (17.1 to 17.8 and 18.1, 18.2).

### BACKGROUND OF THE INVENTION

The invention relates to a fastening system for closing an opening in a structural part using a plate-type material, in particular for fire-proof closing of an opening with a fire-protection plate. The fastening system includes a base element and at least one supporting element, wherein the base element comprises at least one fastening section and wherein the fastening section includes a plurality of receiving means in a predefined spacing for connection to a plurality of supporting elements. The supporting element comprises a first member and at least a second member, wherein an engagement means is arranged on at least one of said members.

Openings are provided in walls for implementing conduit systems, wherein said openings being closed using plate-type material. The openings are closed in a fireproof fashion using appropriate materials so that, in the event of outbreak of fire, the fire cannot spread through such openings in the walls into the building. For example, soft, compressible plates made of mineral wool are cut to the dimensions of the opening and lodged into the opening. Stiff, less deformable plates are fastened directly to the wall using screws. Plates are arranged on both sides of the opening out of aesthetic considerations and/or to make reliable fireproof bulkheading possible. The opening must be accessible from both sides.

The drawback to both of the aforementioned solutions is that many openings are accessible on only one side or are bilaterally accessible only at additional expense. This gives rise to considerable time and costs factors, particularly if the openings are opened for subsequent installations and then have to be closed again.

### SUMMARY OF THE INVENTION

The object of the present invention is to provide a simple and reliable possibility for the assembly of plate-type material in openings, which permits the assembly from one side of the opening to be closed. Furthermore, in the event of change, dismantling and re-assembly of the plates should be possible without the use of tools.

This object is achieved according to the invention by a fastening system for closing openings in a structural part using plate-type material, in particular for fireproof closure of an opening using a fire-protection plate, comprising a base element and at least one supporting element. The base element comprises at least one fastening section, wherein a plurality of receiving elements for connecting a plurality of supporting elements is provided on the fastening section in predefined spacing. The supporting element comprises a first member and at least one second member, wherein an engaging means is arranged on at least one of the members. The base element is platelike and each receiving means is associated with at least one opening for fastening the base element to an intrados of the opening.

Using the platelike configuration of the base element, the fastening system has a minimal structural height. A plate affixed using the fastening system, according to the invention, completely closes off the opening to be closed, which is of decisive significance in fireproof closure of an opening. The base element can be cut to a length corresponding to the thickness of the wall since each receiving means is associated with one fastening bore hole. Fastening of the base element to the intrados of the opening is assured. The installation depth of the plate-type material in the opening is defined by virtue of the positioning of the supporting elements on one of the receiving means of the base element. In the event of dismantling of the plate disposed in the opening, the base element of the fastening system remains affixed to the intrados and said base element is used at the time of subsequent assembly of the plate for connection of the supporting elements that fix said plate.

Two base elements of the fastening system according to the invention are, preferably oriented vertically, mounted on the lateral intrados of the opening. Then one supporting element is arranged behind each receiving means, as viewed when looking in the direction of installation, said supporting element serving as the contact for the rear plate to be installed. In this step, the receiving means for the arrangement of the supporting elements are selected that most closely approximate the desired installation depth of the corresponding plate. The rear plate is cut to the dimensions of the measurements of the opening and installed in the opening. Supporting elements are arranged on all base elements in the receiving means that are adjacent to the installed plate. Then one supporting element is arranged on the base elements, said supporting element serving as the contact for the front plate that is to be installed. The front plate is cut to the dimensions of the measurements of the opening and installed in the opening. One supporting element is arranged in each of all base elements in the receiving means that are on the installed plate, whereby the front plate is fixed. If the length of the base element corresponds to the thickness of the wall, the rearmost receiving means, which serves as the contact for the rear plate, as viewed when looking in the direction of installation, can be fixedly arranged at the factory.

Using the fastening system according to the invention, assembly from one side of the opening is possible. By virtue of the predefined spacing of the receiving means on the base element, the spacing of the plates relative to each other is predefined and costly, time-consuming measurements are eliminated. Any later opening and closing of an installed fireproof bulkhead is possible at any time without the use of tools.

Preferably at least two openings are arranged on each receiving means for fastening the base element. Preferably, the opening for fastening the base element is disposed on an axis that runs transverse to the longitudinal extension of the base element through the respective receiving means. In addition, these openings are preferably spaced equidistant relative to the receiving means. The receiving means are preferably configured so that the engaging means of the supporting elements can be introduced into the receiving means transverse to the longitudinal extension of the base elements. The base element can be arranged on the left or right side on the lateral intrados of the opening.

Preferably, the spacing of the receiving means correspond at least to the length of the member carrying the engaging means of the supporting element. Using this configuration, a plurality of supporting element can be provided next to each other on each receiving means of the base element. For example, this embodiment makes the arrangement of more that two plates in an opening possible, wherein these plates can have different material properties. For example, plates made of an intumescent material and plates made of a material that is difficult to burn as well as plates meeting aesthetic requirements can be installed in an opening.

Advantageously, the receiving means comprises a ‘lug’ and the engaging means comprises at least one hook that can be introduced into the lug. The hooks can be introduced from both sides, transverse to the longitudinal extension of the base element, into the lug. The lugs can be configured by a material deformation on the base element. For example, two slots are created parallel to the longitudinal axis of the base element and the section lying in between projects from the plane of the base element. Alternatively, the lugs can be configured as separate parts that are affixed to the base element by welding or soldering in the desired spacing. Since the mounting parts are affixed perpendicular to the direction of assembly, an unintentional loosening of this connection by a load perpendicular to the plates is eliminated.

Preferably, the base element comprises at least one angled section which is disposed at a right angle transverse to the longitudinal extension of the base element at one of the ends of the fastening section of the base element. The angled section has at least one receiving means for connection of at least one supporting element. The angled section serves as an abutment of the base element at the delimiting wall of the opening. At the time of assembly of the base element, it is aligned by the angled section without the base element having to be measured in. For example, the receiving means are positioned in that same fashion for all assembled base elements regardless of a left or right sided assembly of the base element. In an alternative embodiment thereof, several zones of intended deflection can be provided on the base element, preferably, in a predefined spacing; this makes a user-defined adaptation of the base element possible. Such zones of intended deflection are preferably disposed centrally between two receiving means. At the same time, said zones of intended deflection can be configured in addition as zones of intended break so that, for example, the base element can be adjusted in its length without special tools.

Preferably the second member of the supporting element is oriented substantially perpendicular to the first member of the supporting element. The supporting element is essentially angular, wherein the supporting element can be configured with members of unequal lengths. In this embodiment, one of these members has the engaging means for fastening the supporting element on the base element. The other member is used in affixing the plate installed in the opening.

According to a further embodiment of the supporting element, the second member and the first member of the supporting element lie in one plane. Also in this embodiment, one of these members has the engaging means for affixing the supporting element to the base element. This supporting element is, for example, arranged on the angular section of the base element so that, after its fixation, the front plate is flush in the plane of the surface of the structural component, as viewed in the direction of installation. Furthermore, this supporting element can be deflected to fulfill special requirements and demands of the user. Zones of intentional deflection are provided on the supporting element for this purpose.

Preferably, at least one of the members of the supporting element has a substantially rectangular opening, wherein at least two opposing tabs are configured as engaging means that engage in the receiving means of the base element. The supporting element is preferably configured symmetrical relative to its longitudinal axis so that the supporting element can be arranged on the right or on the left side on a base element. The tabs preferably have local deformations, whereby there is a clamping connection of the tabs introduced into the receiving means, the lugs, for example, with the lugs.

Preferably, there is a receiving means for a plate-type material created by supporting elements arranged adjacent to each other on the base element. The predefined spacing of the receiving means is selected such that the intermediate space between two supporting elements arranged on the base element corresponds approximately to the plate thickness of the plate to be fastened. The spacing of the receiving means relative to each other favors the sum obtained from the plate thickness plus the metal thickness of the supporting element such that a plate can be fastened over the entire installation depth of the opening along the base elements.

The parts of the fastening system are advantageously made of sheet metal punch/bend parts. The material thickness of the base element is preferably selected such that a base element equipped with an angular section has sufficient stability that a fastening on the wall side is adequate for a reliable mounting of the fastening system. Consequently, the fastening system according to the invention can even be arranged in narrow openings, in which an intrados fastening is difficult or event impossible. The base element can, for example, be manufactured as an infinite loop, for example, such that prior to installation it can be adjusted in its length. The base element has zones of intentional deflection or zones of intentional break.

### BRIEF DESCRIPTION OF THE INVENTION

Further advantageous embodiments and combinations of features of the invention will become apparent from the following detailed description with reference to the drawings, wherein:

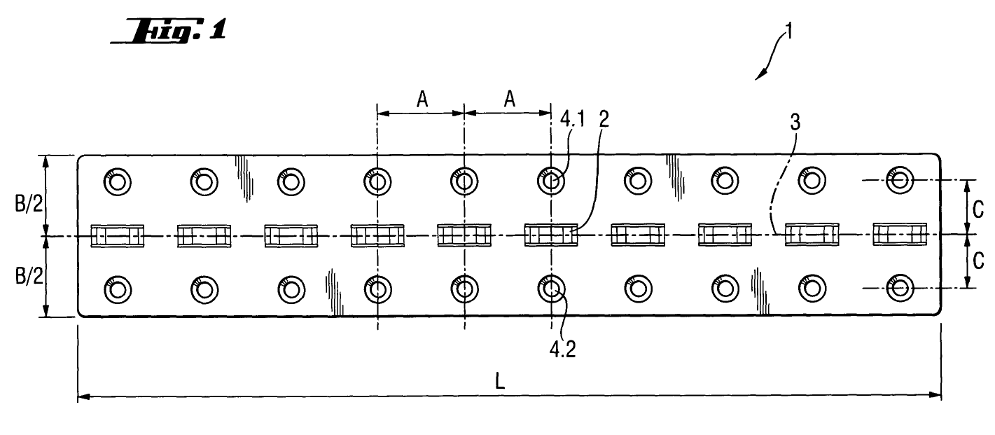

FIG. 1 shows a view onto an exemplary embodiment of the base element according to the invention;

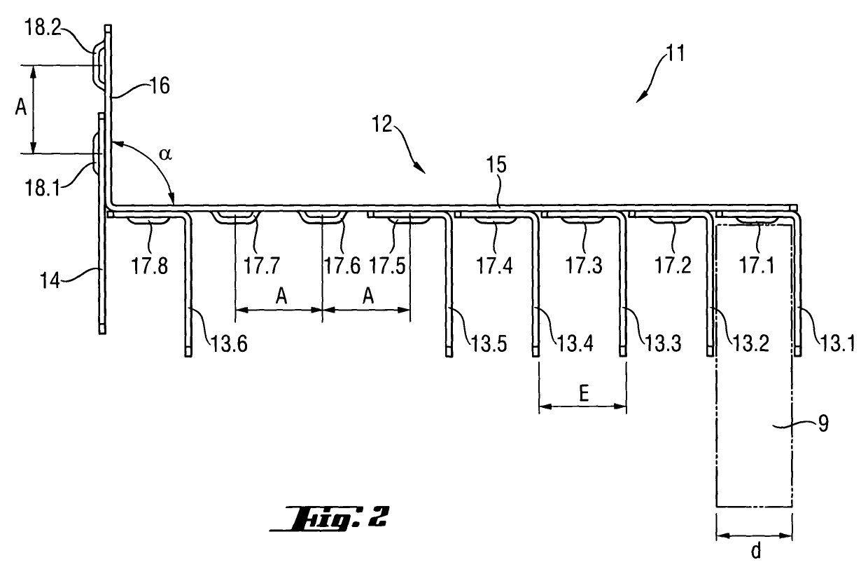

FIG. 2 shows a top view of a fastening system according to the invention;

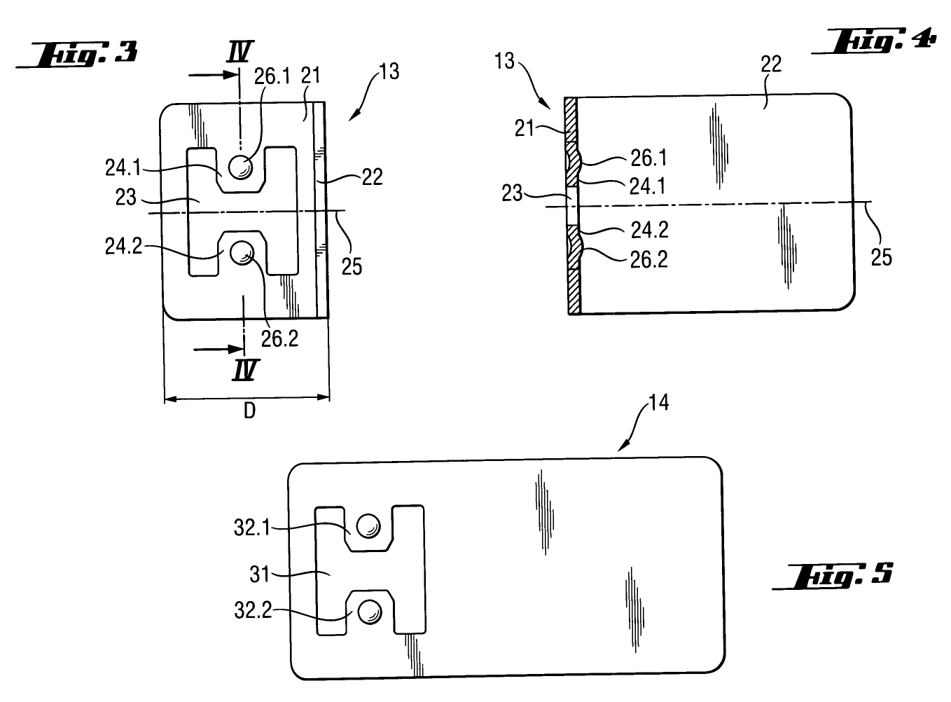

FIG. 3 shows a view onto a first exemplary embodiment of the supporting element according to the invention;

FIG. 4 shows a section through the supporting element of FIG. 3 along the section plane IV-IV according to the invention;

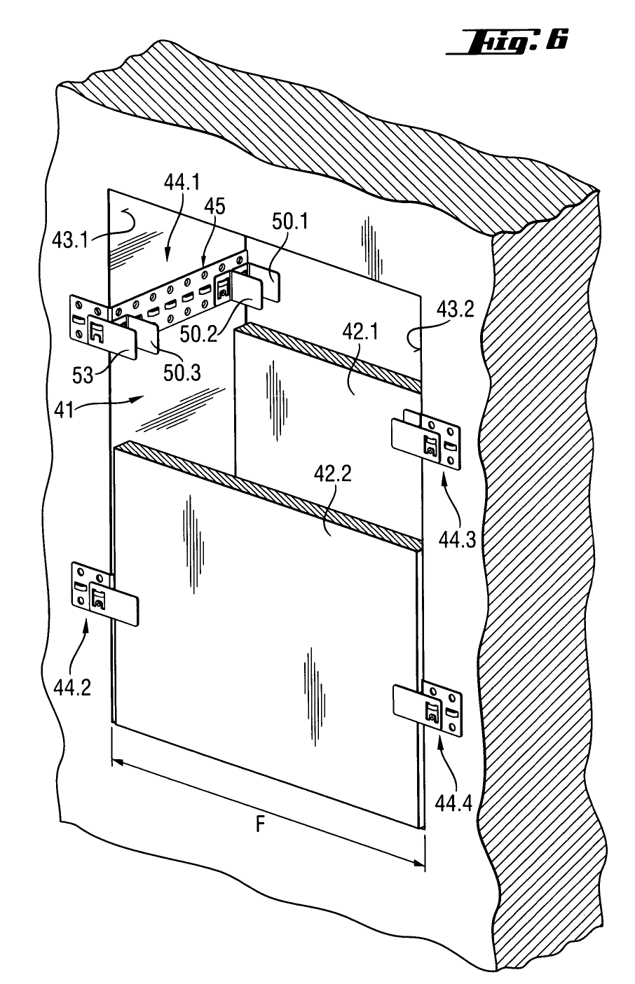

FIG. 5 shows a view onto a second exemplary embodiment of the supporting element according to the invention;

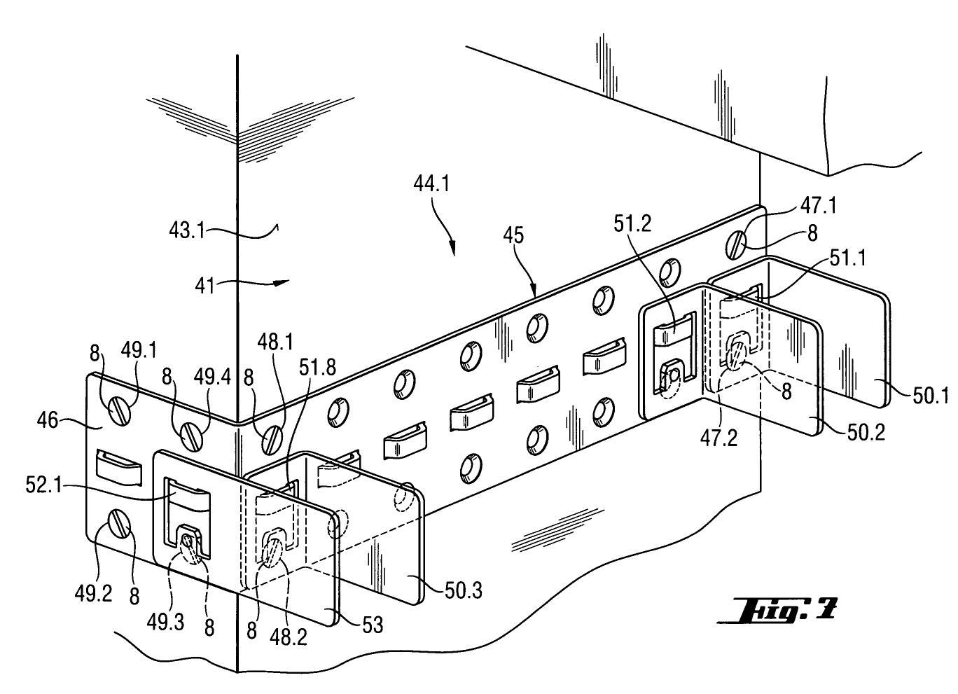

FIG. 6 shows a perspective view of a fireproof bulkhead for an opening with a plurality of fastening systems according to the invention; and

FIG. 7 shows a detailed enlargement of cutout VII in FIG. 6.

### DETAILED DESCRIPTION OF THE INVENTION

Identical parts in the figures are identified using the same references.

FIG. 1 shows a view onto an exemplary embodiment of the base element according to the invention. The base element 1 is manufactured from sheet metal and has a length L, which corresponds to the length of the usual wall thickness (e.g., 200 mm, 250 mm, 300 mm). The lugs 2 are arranged at half width B/2 of the base element 1 along the longitudinal axis 3, in a predefined, uniform grid of distance A of approximately 25 mm. A bore hole 4.1 or 4.2 is provided for fastening of the base element 1 at distance C relative to the longitudinal axis 3. The base element 1 is symmetrical to the longitudinal axis 3 such that the base element 1 can be mounted on the left and right side on an opening. For example, the base element 1 is fastened to one of the intrados of the opening to be closed using fastening screws. In lieu of fastening screws, the base element can be fastened by an appropriate adhesive, for example, to the intrados of the opening. In this type of fastening, the arrangement of the bore holes, for example 4.1 and 4.2, can be omitted.

A top view onto a fastening system according to the invention is shown in FIG. 2. The fastening system 11 comprises a base element 12 and a plurality of supporting elements 13.1 to 13.6 and 14. The base element 12 has a fastening section 15 and an angular section 16, which is configured at an angle α of 90° to the fastening section 15. The length of the fastening section 15 is, in this exemplary embodiment, 200 mm, wherein the base element 12 is used with openings in walls, preferably, having a wall thickness of 200 mm. The base element 12 can also be used in openings in walls with a larger wall thickness, wherein the installation depth of the plate to be fastened, however, is limited to the length of the fastening section 15 of the base element 12.

The base element 12 has lugs 17.1 to 17.8 or 18.1 and 18.2 as receiving means for the supporting elements 13.1 to 13.6 and 14 as well as (not shown here) fastening openings, on the fastening section 15 and on the angular section 16, wherein the lugs 17.1 to 17.8 or 18.1 and 18.2 and fastening openings are arranged essentially analogous to the lugs and bore holes of the base element 1 (see FIG. 1). The spacing A of the lugs 17.1 to 17.8 preferably corresponds to the spacing A of the lugs 2 of the base element 1, whereby the two base elements 1 and 12 are interchangeable and can be used on one and the same opening, depending on the existing circumstances. The two lugs 18.1 and 18.2 are preferably spaced using the spacing A, wherein their spacing and the existing projections determine the length of the angular section.

The distance between two supporting elements, for example the distance E between supporting elements 13.3 and 13.3, preferably corresponds to the thickness d of a plate 9, which is to be fastened using the fastening system 11 in the opening.

FIG. 3 shows a view onto a first exemplary embodiment of the supporting element according to the invention. The angular supporting element 13 has a first member 21 for fastening of the supporting element 13 to a base element 1 or 12 and a second member 22 for fasting to the plate to be fastened. The length D of the first member 21 is configured to be somewhat smaller than the length of the spacing A of the lugs on the base element 1 or 12 so that at two adjacent lugs one supporting element 13 can be provided. H-shaped recess 23 is arranged in the first member 21 so that two tabs 21.1 and 24.1 project into an otherwise rectangular opening. The tabs 24.1 and 24.2 form so-called hooks, which can be introduced into the lugs on the base element 1 or 12. The H-shaped recess 23 is symmetrical relative to the longitudinal axis 25 of the supporting element 13 such that the supporting element 13 can be arranged on the left and on the right on the base element 1 or 12.

FIG. 4 shows a section through the supporting element shown in FIG. 3 along the section line IV-IV. As can be seen in FIG. 3 and FIG. 4, the supporting element 13 is configured with unequal members. Local elevations 26.1 or 26.2 are formed on the tabs 24.1 and 24.2 to assure the connection between the tabs of the supporting element 13 and the lugs of the base element, wherein after arrangement of the supporting element 13 on the base element 1 or 112, a clamp connection is created between these two elements.

A view onto a second exemplary embodiment of the supporting element according to the invention is shown in FIG. 5. The supporting element 14 is configured as a plate and is preferably arranged on the angular section 16 of the base element 12 as a closure element. The front plate can be oriented flush with the wall surface relative to the base element, when seen in the direction of installation, using the arrangement of the supporting element 13.6 on the lug 17.8 and using the arrangement of the supporting element 14 on the lug 18.1. The supporting element 14 has an H-shaped recess 31 with tabs 32.1 and 32.2, which are configured similar to the H-shaped recess 23 and the tabs 24.1 or 24.2 of the supporting element 13.

FIG. 6 shows a perspective view of a fireproof bulkhead for an opening having a plurality of fastening systems according to the invention and FIG. 7 shows a detailed enlargement thereof Using these figures, the assembly process for setting up a bulkhead of the opening 41 using the fastening system 11 according to the invention is described using fire-protection plates 42.1 and 42.2. Two fastening systems 44.1 to 44.4 according to the invention are arranged on the lateral intrados 43.1 and 43.2. In the following, reference is made to the fastening system 44.1 in substitution for all fastening systems 44.1 for the purposes of description. For improved understanding of the following elaboration, the fire-protection plates 42.1 and 42.2. installed in the opening 41 are not drawn in the entire height of the opening, which makes the overall representation of the fastening system 44.1 possible.

The angular section 46 of the base element 45 is used as a positioning aid and after preferable vertical adjustment of the base element 45 it is fasted to the intrados 43.1 by fastening screws 8. The fastening screws 8 are passed through bore holes 47.1, 47.2, 48.1, 48.2. The base element 45 is fastened to the wall surface using fastening screws 8 through the bore holes 49.1 to 49.4 if fastening of the base element 45 on the intrados side is difficult or generally impossible as a result of the longitudinal measurement F of the opening 41.

In this exemplary embodiment, an angular supporting element 50.1 is then arranged on the rearmost lug 51.1 of each base element and serves as a support for the rear fire-protection plate 42.1 that is to be installed. In this step, the lugs for the arrangement of the supporting element 50.1 that most closely approximate the desired installation depth of the corresponding fire-protection plate are selected. The rear fire-protection plate 42.1 is cut to the dimensions of the opening 41 and installed in the opening 41. An additional angular supporting element 50.2 is arranged in the lug 5.1.2 adjacent to the previously described lug 51.1 to which the rear fire-protection plate 42.1 is fastened.

A further angular supporting element 50.3 is then arranged on the foremost lug 51.8 of the fastening section of each base element, whereby the supporting element 50.3 is used as the support for the front fire-protection plate 42.2 that is to be installed. The front fire protection plate 42.2 is cut to the dimensions of the opening 41 and installed in the opening 41. A flat supporting element is arranged in the lug 52.1 on the angular element 46 of each base element, with which the front fire-protection plate 42.2 is also affixed. The opening 41 is closed flush.

In summary, it must be noted that a simple and reliable possibility for assembling a plate-type material in openings is provided, which makes the assembly from one side of the opening to be closed possible. Changes to the bulkheads created using the fastening system according to the invention can be made without the use of tools.

What is claimed is:

1. A fastening system for closing an opening in a structural part with a plate, the fastening system (11; 44.1 to 44.4) comprises a base element (1; 12; 45) and at least one supporting element (13, 13.1 to 13.6, 14; 50.1, 50.2, 50.3, 53), wherein the base element (1; 12; 45) comprises at least one fastening section (15), wherein a plurality of receiving means (2; 17.1 to 17.8, 18.1, 18.2; 51.1, 51.2, 51.8) are provided on the fastening section (15) in a predefined spacing (A) for connection of a plurality of supporting elements (13, 13.1 to 13.6, 14; 31; 50.1, 50.2, 50.3, 53) and each of the supporting elements (13, 13.1 to 13.6, 14; 31; 50.1, 50.2, 50.3, 53) comprise a first member (21) and at least one second member (22), wherein an engaging means (24.1, 24.2; 31.1, 32.2) is arranged at least on one of the members (21), wherein the base element (1; 12; 45) is platelike and each of the receiving means (2; 17.1 to 17.8, 18.1, 18.2; 51.1, 51.2, 51.8) is associated with at least one opening (4.1, 4.2; 47.1, 47.2, 48.1, 48.2, 49.1 to 49.4) for fastening the base element (1; 12; 45) to an intrados (43.1, 43.2) of the opening (41).

2. The fastening system of claim 1, wherein at least two openings (4.1, 4.2; 47.1, 47.2, 48.1, 49.1 to 49.4) are associated with each of the receiving means (2; 17.1 to 17.8, 18.1, 18.2; 51.1, 51.2, 51.8) for fastening the base element (1; 12; 45).

3. The fastening system of claim 1, wherein the distance (A) of the receiving means (2; 17.1 to 17.8, 18.1, 18.2; 51.1, 51.2, 51.8) corresponds at least to the length (D) of the engaging means (24.1, 14.2; 32.1, 32.2) carrying first member (21) of the supporting element (13, 13.1 to 13.6, 14; 50.1, 50.2, 50.3, 53).

4. The fastening system of claim 1, wherein the receiving means comprises a lug (2; 17.1 to 17.8, 18.1, 18.2; 51.1, 51.2, 51.8) and the engaging means comprises at least one hook (24.1, 24.2; 32.1, 32.2) introduceable into the lug (2; 17.1 to 17.8, 18.1, 18.2; 51.1, 51.2, 51.8).

5. The fastening system of claim 1, wherein the base element (12; 15) comprises at least one angular section (16; 46) arranged rectangular transverse to the longitudinal extension of the base element (12; 45) at one of the ends of the fastening section (15) of the base element (12; 45) and the angular section (16; 46) has at least one receiving means (18.1, 18.2; 52.1) for connecting at least one supporting element (14; 53).

6. The fastening system of claim 1, wherein the second member (22) of the supporting element (13; 13.1 to 13.6; 50.1 to 50.3) is vertical to the first member (21) of the supporting element (13; 13.1 to 13.6; 50.1 to 50.3).

7. The fastening system of claim 1, wherein the second member and the first member of the supporting element (14; 53) lie in one plane.

8. The fastening system of claim 1, wherein at least one of the members (21) of the supporting element (13; 13.1 to 13.6; 50.1 to 50.3) has a rectangular opening (23; 31) and wherein at least two opposing arranged tabs (24.1, 24.2; 32.1, 32.2) are engaging means engaging into the receiving means (2; 17.1 to 17.8, 18.1, 18.2; 51.1, 51.2, 51.8) of the base element (1; 12, 45).

9. The fastening system of claim 1, wherein a receptacle for a plate-type material (42.1, 42.2) is created using two supporting elements (13.1, 13.2; 13.2, 13.3; 13.3, 13.4; 13.4, 13.5; 13.6, 14; 50.1, 50.2; 50.3, 53) arranged adjacent to each other on the base element (1; 12; 45).

10. The fastening system of claim 1, wherein the parts of the fastening system are sheet metal punch/bend parts.

11. The fastening system of claim 1, wherein the plate is formed as a fire-protection plate (42.1, 42.2) for fire-proof closing of the opening (4).
